(19) United States
(12) Patent Application Publication
(10) Pub. No.: US 2004/0261455 A1
(43) Pub. Date: Dec. 30, 2004

(54) Process for preparation of glass optical element

(75) Inventors: Takashi Igari, Iida-shi (JP); Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/747,091

(22) Filed: Dec. 30, 2003

(30) Foreign Application Priority Data
Jan. 9, 2003 (JP) 2003-002689

(51) Int. Cl. C03B 40/02

(52) U.S. Cl. 65/24

(57) ABSTRACT

A method of manufacturing optical glass elements comprising the step of press molding a preformed glass material while in a heat-softened state, which material having a carbon film on a surface thereof, to transfer a molding surface of a pressing mold. The carbon film is less than or equal to 10 nm in thickness and is formed in such a manner that after press molding, a carbon film comprising at least two carbon atom layers in thickness is present on the surface of the optical glass element that has been molded by the molding surface. In the method of manufacturing glass elements, fusion between the glass material and the molding surfaces, flaws, and breach are prevented and fogging does not occur on the surface of the optical element obtained.

### TECHNICAL FIELD

The present invention relates to a method of obtaining optical glass elements by heat softening and press molding glass materials that have been preformed to a prescribed shape. More particularly, the present invention relates to a method of manufacturing optical glass elements of prescribed surface precision and optical properties without the need for grinding and polishing following molding.

### BACKGROUND ART

In the course of obtaining an optical element such as a lens by heat softening a glass material and press molding it in a pressing mold that has been processed to a prescribed shape, the providing of a mold-separation film in the form of a thin carbon-base film, thin noble metal-base film, thin nitride-base film, or thin boride-base film on the molding surface is known to prevent fusion of the glass material to the molding surface of the pressing mold and achieve good mold-separation properties.

However, it is difficult to obtain an adequate mold-separation effect with existing mold-separation films when the glass material employed is a glass tending to yield molded products with damage such as flaws and cracks during pressing, such as a borate-base glass, phosphate-base glass, borophosphate-base glass, or fluorophosphate-base glass.

Forming a film of carbon or the like on the surface of the glass material is another technique known to prevent fusion.

Examined Japanese Patent Publication (KOKOKU) Heisei No. 2-31012 (Patent Reference 1) describes a method of preventing fusion by forming a carbon film on at least one of the opposing surfaces of the glass and the mold.

Examined Japanese Patent Publication (KOKOKU) Heisei No. 7-45329 (Patent Reference 2) describes the prevention of fusion and the improvement of mold separation by forming a hydrocarbon film on the surface of the glass material employed in molding.

Unexamined Japanese Patent Publication (KOKAI) Heisei No. 8-217468 (Patent Reference 3) describes the prevention of fusion by providing a thin carbon film formed by heat decomposition of high-purity acetylene on the surface of the glass material.

Unexamined Japanese Patent Publication (KOKAI) Heisei No. 9-286625 (Patent Reference 4) describes improvement in mold separation by employing a methane plasma treatment to form a carbon film less than 5 nm in thickness, desirably less than 1 nm in thickness, on the surface of the glass material employed in molding.

These methods are somewhat effective in improving mold separation. However, they are unable to prevent microfusion (“microfusion” as used herein refers to fusion at the sub-micron level or below), and in continuous pressing exceeding 1,000 shots, fail to prevent the generation of flaws and cracks. Further, depending on the type of glass employed, fogging and the like is generated on the surface of the optical glass element that is molded. Thus, these methods are unsatisfactory.

The present invention, devised in light of the above-stated situation, has for its object to provide a method of manufacturing glass elements in which fusion between the glass material and the molding surfaces, flaws, and breach are prevented and in which fogging does not occur on the surface of the optical element obtained.

### SUMMARY OF THE INVENTION

The present invention, solving the above-stated problems, is as follows.

(1) A method of manufacturing optical glass elements comprising the step of press molding a preformed glass material while in a heat-softened state, which material having a carbon film on a surface thereof, to transfer a molding surface of a pressing mold,

characterized in that the carbon film is less than or equal to 10 nm in thickness and is formed in such a manner that after press molding, a carbon film comprising at least two carbon atom layers in thickness is present on the surface of the optical glass element that has been molded by the molding surface.

(2) A method of manufacturing optical glass elements comprising the step of press molding a preformed glass material while in a heat-softened state, which material having a carbon film on a surface thereof, to transfer a molding surface of a pressing mold,

characterized in that the carbon film is less than or equal to 10 nm in thickness and is formed in such a manner that after press molding, a carbon film of at least 0.5 nm in thickness is present on the surface of the optical glass element that has been molded by the molding surface.

(3) A method of manufacturing optical glass elements comprising the step of press molding a preformed glass material while in a heat-softened state, which material having a self-assembled film on a surface thereof, to transfer a molding surface of a pressing mold,

characterized in that the self-assembled film is less than or equal to 10 nm in thickness and is formed in such a manner that after press molding, a carbon film comprising at least two carbon atom layers in thickness is present on the surface of the optical glass element that has been press molded by the molding surface.

(4) A method of manufacturing optical glass elements comprising the step of press molding a preformed glass material while in a heat-softened state, which material having a self-assembled film on a surface thereof, to transfer a molding surface of a pressing mold,

characterized in that the self-assembled film is less than or equal to 10 nm in thickness and is formed in such a manner that after press molding, a carbon film of at least 0.5 nm in thickness is present on the surface of the optical glass element that has been molded by the molding surface.

(5) The manufacturing method according to any of (1) to (4) in which the thickness of the carbon film or self-assembled film provided on the surface of the glass material is predetermined based on the shape of the glass material and the shape of the optical element so that a carbon film at least two carbon atom layers or at least 0.5 nm in thickness is present on the surface of the optical glass element after press molding.

(6) The manufacturing method according to any of (1) to (5) in which the carbon film or self-assembled film is formed so that the rate of increase in the hydrogen content of the surface layer portion from the glass surface of the glass material to a depth of 500 nm is less than or equal to 5 at %.

(7) The manufacturing method according to any of (1) to (6), further characterized in that the carbon film on the glass material is formed by vapor deposition, sputtering, or ion plating, and in that the self-assembled film on the glass material is formed by a self-assembled film-forming method.

(8) The manufacturing method according to any of (1) to (7), further characterized in that an optical element having an optically functional surface and an optically nonfunctional surface, the optically nonfunctional surface having a peripheral portion which is discontinuous with the shape of the optically functional surface, is manufactured by the press molding.

(9) A method of manufacturing optical glass elements comprising the step of press molding a preformed glass material while in a heat-softened state, which material having a carbon film or a self-assembled film on a surface thereof, to transfer a molding surface of a pressing mold, characterized in that:

press molding is conducted with a dummy glass material to obtain a dummy optical element;

the portion of the surface that has been press molded by the molding surface and undergone the highest rate of expansion in surface area due to press molding is determined;

the thickness of the carbon film or self-assembled film to be formed on the glass material is determined based on the expansion rate of the surface area of the above portion;

a carbon film or self-assembled film of the determined thickness is formed on the glass material; and

the glass material on which the film has been formed is press molded.

(10) The manufacturing method according to (9), further characterized in that:

a dummy glass material marked with a prescribed pattern on the surface thereof is employed as the dummy glass material and

the position with the highest expansion rate is determined based on the marks on the dummy glass material and marks on the surface of a dummy glass element obtained using the dummy glass material marked with a prescribed pattern on the surface thereof.

(11) A method of manufacturing optical glass elements comprising the step of press molding a preformed glass material while in a heat-softened state, which material having a carbon film on a surface thereof, to transfer a molding surface of a pressing mold, characterized in that:

the carbon film is formed by vapor deposition or sputtering; and

the thickness of the carbon film is less than 5 nm.

(12) The manufacturing method according to (11), further characterized in that the carbon film is formed in such a manner that after press molding, a carbon film at least two carbon atom layers in thickness is present on the surface of the optical glass element that has been press molded by the molding surface.

### BRIEF DESCRIPTION OF THE FIGURES

FIG. 1 is a schematic drawing of extension of the carbon film due to press molding.

FIG. 2 is a drawing descriptive of a self-assembled film.

FIG. 3 shows the shape of the lens of Embodiment 1.

FIG. 4 is an example of the results of IR-RAS analysis of a self-assembled film.

FIG. 5 is a schematic of a surface friction gauge.

FIG. 6 gives the output results of a surface friction gauge.

FIG. 7 gives the output results of a surface friction gauge.

### KEY TO THE NUMERALS

1 A solution (coating solution) containing the starting materials of a self-assembling film

2 Molecules within the solution

3 Base material on which film is to be formed

4 Self-assembled film

5 Molecules of self-assembled film

11 Base material on which film has been formed (sample)

12 Sample holder and Y stage for friction operation

13 Spherical slider

14 Load-bearing arm

15 X stage for applying load

16 Load plate spring

17 Displacement sensor for detecting load

18 Frictional force plate spring

19 Displacement sensor for detecting frictional force

According to the present invention, in the course of manufacturing an optical element by press molding with a pressing mold a glass material having a carbon film or a self-assembled film, the thickness of the carbon film or self-assembled film is predetermined based on the rate of expansion of surface area due to press molding. In the course of molding a glass material provided with a carbon film or self-assembled film of a thickness falling within a prescribed range, it is possible to prevent fusion and resultant flaws and cracks.

Further, according to the present invention, when employing a glass material provided with a carbon film or self-assembled film, the entry of active hydrogen into the glass material surface is prevented during film formation and a glass material is employed that exhibits a hydrogen content not exceeding the hydrogen content prior to film formation by more than a certain amount. Thus, fogging and clouding of the optical element and damaging of the molding surface are prevented, the service life of the mold-separation film of the pressing mold is extended, and the frequency of replacement of the mold-separation film is reduced. This is advantageous in terms of production cost and efficiency.

[Best Mode of Implementing the Invention]

The method of manufacturing optical glass elements of the present invention comprises the step of press molding a preformed glass material while in a heat-softened state, which material having a carbon film on a surface thereof, to transfer the molding surface of the pressing mold.

A first mode of the method of manufacturing optical glass elements of the present invention is characterized in that the carbon film is less than or equal to 10 nm in thickness and is formed in such a manner that a carbon film comprising at least two carbon atom layers in thickness remains on the surface of the optical glass element following press molding. In this regard, the surface of the optical glass element following press molding is the surface that has been prepared by press molding with the molding surface of the pressing mold.

A second mode of the method of manufacturing optical glass element of the present invention is characterized in that the carbon film is less than or equal to 10 nm in thickness and is formed in such a manner that a carbon film at least 0.5 nm in thickness remains on the surface of the optical glass element following press molding. In this regard, the surface of the optical glass element following press molding is the surface that has been prepared by press molding with the molding surface of the pressing mold.

A desired optical element is obtained by press molding a glass material while in a heat-softened state to extend and deform the glass material and transfer the surface shape of the molding surface of the pressing mold. When press molding a glass material having a carbon film or the like on the surface thereof, deformation of the glass material is accompanied by extension of the carbon film on the surface. When extension of the carbon film cannot keep up with deformation of the glass material, breach occurs. Thus, the glass material is exposed at the breached portions, resulting in the risk of fusion to the molding surface and in flaws and cracks caused by such fusion. The carbon film referred to here includes the case where less than 50 at %, preferably less than 30 at %, of other substances such as hydrogen are contained.

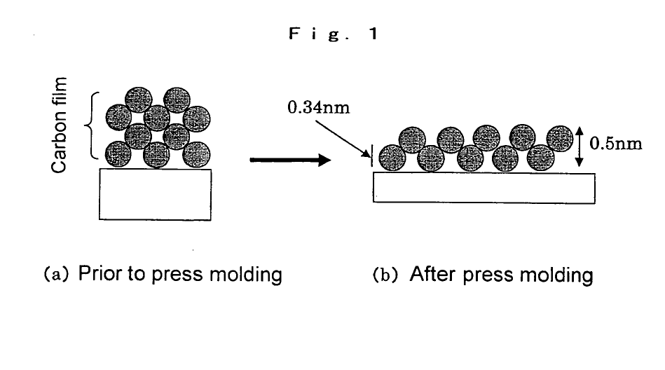

Accordingly, as shown in FIG. 1, in the process of extending the carbon film provided on the surface of the glass material by pressing, extension occurs with deformation of the glass surface, and contact between the glass and molding surface must be continuously prevented.

As the surface of the glass material is extended by pressing, the surface area of the glass material increases and the surface area of the carbon film increases. As a result, when the thickness of the carbon film is excessively thin, gaps (breach) occur in the carbon film. The present inventors conducted extensive research, resulting in the discovery that the carbon atoms constituting the carbon film undergo a sliding movement as the carbon film extends, and that at least two layers of carbon atoms must be present on the glass surface through the final stage of extension by pressing. The first layer of carbon atoms on the glass surface adheres to the glass and thus does not move, while the second and subsequent layers of carbon atoms undergo sliding movement.

Accordingly, in the first mode of the method of manufacturing optical glass elements of the present invention, the carbon film on the glass material is formed so that a carbon film having a thickness of at least two carbon atom layers is present on the surface of the optical glass element following press molding. A carbon film having a thickness of at least two carbon atom layers must be present on the surface of the optical glass element following press molding because this surface is pressed by the molding surface of the pressing mold. The carbon film present on other surfaces of the optical glass element may be only one atom thick or completely absent.

As shown in FIG. 1(b), when carbon atoms are present on the surface of an optical element that has been deformed by press molding and the film thickness is greater than or equal to two carbon atom layers, fusion does not occur with the molding surface during press molding. The carbon atoms in the two atom layers do not have to be arranged in a state of closest packing, but must be arranged in a state adequate to fully cover the entire glass surface. Accordingly, the thickness of the carbon film comprising the two layers of carbon atoms is greater than or equal to about 0.5 nm. Here, the theoretical radius of a carbon atom is the van der Waals radius of 0.17 nm.

Accordingly, in the second mode of the method of manufacturing optical glass elements of the present invention, the carbon film formed on the glass material is formed so that a carbon film having a thickness of at least 0.5 nm is present on the surface of the optical glass element following press molding. A carbon film having a thickness of at least 0.5 nm must be present on the surface of the optical glass element following press molding because this surface is pressed by the molding surface of the pressing mold. The carbon film present on other surfaces of the optical glass element may be less than 0.5 nm thick or completely absent.

Accordingly, a carbon film of predetermined thickness is formed on the glass material so that a carbon film at least two atom layers or 0.5 nm thick remains on the surface of the glass element following press molding. Two atom layers or 0.5 nm is the minimum film thickness. On the surface pressed by the molding surface of the pressing mold, the carbon film need only have a thickness greater than or equal to the above-stated minimum film thickness, and need not necessarily be uniform. When the film is not of uniform thickness, it suffices for the thinnest portion of the film to be two atom layers or 0.5 nm thick. Further, the rate of deformation of the surface of the glass material may vary depending on the shape of the glass material and the shape of the glass element sometimes. Thus, even when an approximately uniform carbon film has been provided on the glass material prior to press molding, highly deformed portions of the carbon film where the surface area has increased will have thinner carbon films following press molding than little-deformed portions of the carbon film where there has been little increase in surface area. In the present invention, the thickness of the carbon film at its thinnest point is at least two atom layers or 0.5 nm.

Further, the thickness of the carbon film on the glass material (prior to press molding) must not exceed 10 nm. This is the film thickness of the carbon film on the surface of the glass material that is pressed by the molding surface of the pressing mold. This film thickness need not be uniform. When not uniform, it suffices for the maximum thickness of the film to be less than or equal to 10 nm.

When the thickness of the carbon film on the glass material exceeds 10 nm, the aggregated carbon atoms adopt a structural regularity. The interaction between atoms precludes a smooth sliding movement between carbon atoms, causing the carbon film tend not to extend. Accordingly, when even only a portion of the carbon film exceeds a thickness of 10 nm, it will not necessarily be sufficient to prevent microfusion, and the formation of flaws and cracks during continuous pressing exceeding 1,000 shots cannot be completely avoided. From this perspective, the thickness of the carbon film is set to less than or equal to 10 nm, with less than 5 nm being preferred.

The thickness of the carbon film or self-assembled film provided on the surface of the glass material is predetermined based on the shape of the glass material and the shape of the optical glass element so that the thickness of the carbon film on the surface of the optical glass element following press molding is at least two atom layers or 0.5 nm. That is, the thickness of the carbon film provided on the glass material is predetermined based on the change in surface area during deformation due to pressing of the glass material.

For example, when a glass element of prescribed shape is formed through nearly uniform extension of the surface area of the glass material as a result of press molding, denoting the surface area of the glass material as S(PF), the surface area of the molded glass element as S(L), and the thickness of the carbon film provided on the glass material as T, it suffices for T to satisfy the following conditions:

0.5×S(L)/S(PF)>T≦10 (nm)

The two carbon atom layers are desirably arranged in a manner without gaps (in a state where a carbon film 0.6 nm in thickness is present) on the surface of the optical element following press molding. Thus, a glass material satisfying the following equation is desirable.

0.6×S(L)/S(PF)≦T≦10 (nm)

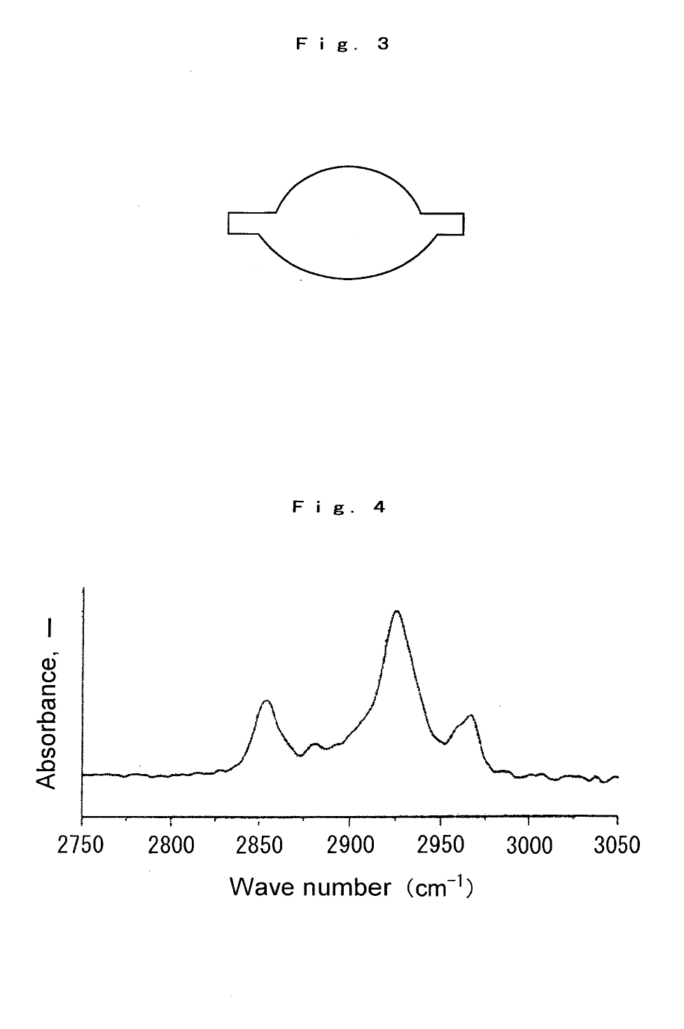

Change in surface area may vary with position on the surface of the glass material according to change in the shape of the glass material of prescribed shape during pressing. That is, some portions will undergo large amounts of extension and other portions will undergo little extension. In that case, a film of a thickness such that at least two carbon atom layers remain on the glass element following molding must be provided on the glass element. For example, in the press molding of a spherical, oblate spherical, or tabular glass preform (preformed glass material) to form an optical element having an optically functional surface surrounded by an optically nonfunctional surface, when there is on the optically nonfunctional surface a surface that is formed into a shape (often employed as the mounting portion of an optical element; see FIG. 3) that is discontinuous with the shape of the surface constituting the optically functional surface, the portion that is discontinuous in shape undergoes the greatest change in shape during press molding and has the greatest rate of increase in surface area. Thus, it is necessary to predetermine at least the thickness T of the carbon film provided on the glass material based on the expansion rate at that position [S(L)/S(PF)].

In the area undergoing maximum change in shape during press molding—this not being limited to the peripheral portion of the optical element, but including any portion, such as within the optically active surface—a thickness T satisfying the above-stated relation is employed.

To calculate the expansion rate (S(L)/S(PF)) of the portion undergoing the greatest expansion in surface area, it is possible to measure and analyze the three-dimensional shape. A glass preform of prescribed shape the surface layer of which has been doped with a monitoring agent (coloring agent, peculiar component not contained in the glass, isotope, or the like) is pressed, and following pressing, the change in the concentration of the monitoring agent on the surface of the pressed product can be measured to determine (S(L)/S(PF)). A glass preform of prescribed shape the surface layer of which has been coated with carbon can be pressed, and the change in thickness of the carbon on the surface of the pressed product can be measured to determine (S(L)/S(PF)). Based on the analysis of the actual measurement data, the expansion rate can also be calculated by running a simulation.

Alternatively, the surface area expansion rate can also be calculated by the following method. A glass material (dummy glass material) is marked with a series of dots in a certain regular pattern. For example, the marks are made in a prescribed radiating, concentric, or other pattern. The glass material is then press molded, after which the marks on the optical element obtained (dummy optical element) are compared with the marks on the dummy glass material. It is then possible to calculate the surface area expansion rate at each point on the optical element from the intervals of change. The marks are made with a material that does not undergo thermal decomposition at the pressing temperature. A desirable example is a color containing carbon black.

This method is desirable because it permits extremely simple measurement of the surface area expansion rate and change based on location. That is, in a method of manufacturing optical glass elements comprising the step of press molding while in a heat-softened state a preformed glass material having a carbon film or a self-assembled film on a surface thereof to transfer the molding surface of the pressing mold, press molding is conducted with a dummy glass material to obtain a dummy optical element and the portion of the surface that has been press molded by the molding surface where the expansion rate of the surface area due to press molding is the highest is determined; the thickness of the carbon film or self-assembled film to be formed on the glass material is determined based on the expansion rate of the surface area of that portion; a carbon film or self-assembled film of the determined thickness is formed on the glass material; and the glass material on which the film has been formed is press molded.

Specifically, it is desirable to employ a dummy glass material marked with a prescribed pattern on the surface thereof and determine the position of the highest expansion rate based on the marks on the dummy glass material and marks on the surface of a dummy glass element obtained using the dummy glass material marked with a prescribed pattern on the surface thereof.

The thickness of the carbon film formed on a glass material and the thickness of the carbon film formed on an optical element following press molding can be measured with an ESCA (XPS, X-ray photoelectron spectroscopic) or time of flight secondary ion mass spectrometric (TOF-SIMS) analyzer; a surface-topography measuring device such as an atomic force microscope (AMF) or tracer needle film thickness meter; or optical measurement device such as an ellipsometer. However, thin films that are difficult to measure with such analytical devices can be analyzed by measuring the surface friction of the carbon film.

For example, the thickness of a carbon film on a base material (for example, a molded glass lens) can be analyzed as set forth below.

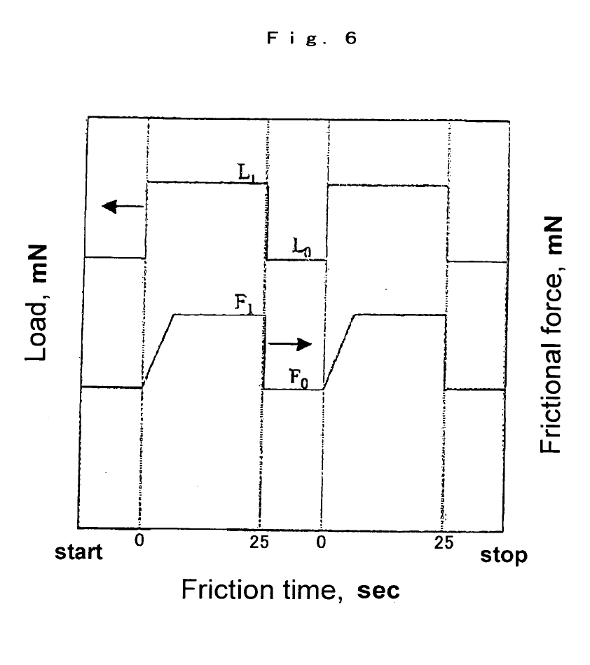

A spherical slider is pressed with a prescribed load (L) against a carbon film in an atmosphere of controlled temperature and humidity (for example, 25° C. and 10 Rh %). A load of about several mN is suitable. Then, with the load still applied, the sphere is made to slide relative to the base material and the frictional force F generated is detected with a surface friction gauge. The surface friction gauge can be of the sort shown in FIG. 5, detecting the deformation of a member (here, a plate spring) accompanying friction by means of a displacement gauge. A rubbing speed during sliding of not greater than several micrometers/s is suitable from the perspective of the original goal of measurement precision.

The surface friction gauge will be described using FIG. 5.

A coated base material (in this case, a molded glass lens) 11 is secured by a sample holder 12 capable of moving in the Y direction. Spherical slider 13 is secured, and the sample is moved in the direction of spherical slider 13 with load-applying X stage 15, resulting in contact and the application of a prescribed load. At that time, load plate spring 16 produces a deflection corresponding to the magnitude of the load applied. The amount of this deflection is detected by load detecting displacement sensor 17. The load can be calculated by multiplying the amount of deflection detected by load detecting displacement sensor 17 with the spring constant of load plate spring 16. After applying the load, sample holder 12 is moved in the Y direction at a prescribed speed and sample 11 is rubbed by spherical slider 13. The frictional force generated by rubbing displaces frictional force plate spring 18. At that time, a deflection is generated corresponding to the magnitude of the frictional force produced by frictional force plate spring 18. The amount of this displacement is detected by friction force detecting displacement sensor 19. The friction force can be calculated by multiplying the amount of displacement detected by frictional force detecting displacement sensor 19 with the spring constant of frictional force plate spring 18. Sensors 17 and 19 are desirably independently secured by fastener (not shown).

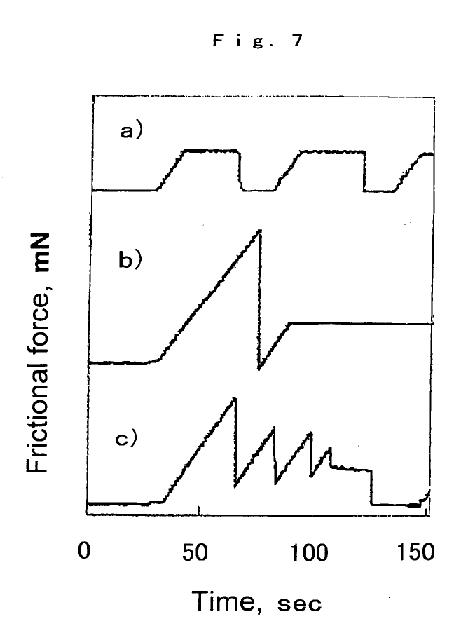

After rubbing for a certain time (=certain distance), rubbing is stopped and the load is released. The output of the surface friction gauge at that time is shown in FIGS. 6 and 7. In FIG. 6, the X-axis denotes elapsed time, the left vertical axis denotes the load, and the right vertical axis denotes frictional force. At time 0, load L1 is applied and rubbing starts. The frictional force gradually increases as rubbing starts, exhibiting a certain value. Let F1 denote this value. After rubbing for a certain time at a certain load, the load is fully released. The values at that time are adopted as starting points and denoted as L0 and F0. Thus, the coefficient of friction can be calculated as (F1−F0)/(L1−L0). At approximately 0.5 or less, the film thickness of the present invention can be considered to be greater than or equal to two carbon atoms.

In FIG. 7, a) shows the same state as in FIG. 6. However, b) and c) show states in which the film thickness is inadequate; that is, since a film does not suffices two carbon atoms thick, the carbon is incapable of undergoing movement by sliding and a stick-slip phenomenon occurs on the film surface. This has occurred four times in c). Based on the above, the limit film thickness at which movement by sliding is possible is 0.5 nm, as shows in FIG. 1(b).

The glass material employed in the present invention may be preformed to be spherical, oblate spherical, or tabular. However, the glass material employed in the manufacturing method of the present invention is not limited to these shapes. Even when employing glass materials not of these shapes, desired optical elements can be molded without flaws or cracks without specifically providing a polishing step to approximate the shape of the optical glass element that has been molded. Accordingly, since it is possible to cause a specified weight of glass melt to flow out, hot form a glass material of the above-stated shape, and feed it to press molding as is, both convenience and economy are achieved.

Following press molding, the optical element may be annealed as needed. In the course of annealing, it is possible to remove the carbon film by heating in an oxidizing atmosphere. When providing a functional film (such as an antireflective film) on the surface of an optical element, it is desirable to remove the carbon film before forming the functional film.

The glass material with the carbon film employed in press molding of the present invention can be formed by a film forming method such as vapor deposition, sputtering, or ion plating. The carbon films formed by such film forming methods afford the advantages that interaction between carbon atoms is relatively little and there is a tendency that atoms suitably slide relative to each other according to expansion in pressing. In particular, carbon films formed by vapor deposition and sputtering are desirable from the perspective of the tendency of the carbon atoms to move by sliding. That is, a carbon film less than or equal to 10 nm in thickness, preferably less than 5 nm in thickness, that has been formed by vapor deposition or sputtering is desirable. A suitable is a carbon film of this type, which is as well formed so that a carbon film comprising at least two carbon atom layers or having a thickness of greater than or equal to 0.5 nm is present on the surface of the optical element following press molding.

To form a carbon film by vapor deposition, a known vapor deposition device is employed. In a vacuum atmosphere of about 10⁻4 Torr, a carbon material is heated with an electron beam, direct current, or an arc, and carbon vapor generated from the material by evaporation or sublimation is transported to the base material, where it condenses and deposits. When applying a direct current, approximately 100 V and 50 A of electricity is run through a carbon material about 0.1 cm² in cross-sectional area to electrically heat the carbon material. The base material is desirably heated to a temperature of from room temperature to about 400° C. However, when the glass transition temperature (Tg) of the base material is less than or equal to 450° C., the maximum temperature to which the base material may be heated is suitably set to 50° C. below Tg.

In that case, a prescribed film thickness can be achieved as follows. The thickness of the carbon film, in the same manner as in common optical thin films, can be actually measured by monitoring the change in the reflectance, change in transmissivity, or quartz crystal microbalance (QCM) of the film deposited on a piece of monitor glass. The thickness of the carbon film can be controlled by opening and closing shutters.

When employing the ion plating method, for example, a known ion-plating device is employed to heat a carbon material with an electron beam in an argon atmosphere of about 10⁻² to 10⁻⁴ Torr. Carbon vapor generated by evaporation or sublimation of the material is caused to deposit on a negatively biased base material to form a thin carbon film. A glow discharge between a filament and a base material electrode enhances the adhesion strength and uniformity of deposition. The base material is desirably heated to a temperature of from about room temperature to 400° C. However, when the glass transition temperature (Tg) of the base material is less than or equal to 450° C., the maximum temperature to which the base material may be heated is suitably set to 50° C. below Tg. In that case, a prescribed film thickness can be achieved in the same manner as set forth above for the vapor deposition method.

In sputtering, a known sputtering device is employed to sputter a carbon target material with argon ions in an argon atmosphere of about 10⁻² to 10⁻³ Torr. The sputtered carbon particles are transported, depositing carbon particles on the base material surface and forming a thin carbon film. The base material is desirably heated to a temperature of from about room temperature to 400° C. However, when the glass transition temperature (Tg) of the base material is less than or equal to 450° C., the maximum temperature to which the base material may be heated is suitably set to 50° C. below Tg. In the same manner as for normal optical thin films, the change in reflectance or transmissivity of the sputtered film on a piece of monitor glass can be measured and the thickness of the carbon film can be controlled by opening and closing shutters.

In another mode of the method of manufacturing optical glass elements of the present invention, a press molding step is included in which a molding surface of a pressing mold is transferred to a preformed glass material having a self-assembled film on a surface thereof while in a heat-softened state.

The third mode of the method of manufacturing optical glass elements of the present invention is characterized in that the self-assembled film has a maximum thickness of less than or equal to 10 nm and is formed so that a carbon film comprising at least two carbon atom layers is present on the surface of the optical glass element following press molding. In this regard, the surface of the optical glass element following press molding is the surface that has been prepared by press molding with the molding surface of the press mold.

The fourth mode of the method of manufacturing optical glass elements of the present invention is characterized in that a self-assembled film has a maximum thickness of less than or equal to 10 nm and is formed so that a carbon film with a thickness of at least 0.5 nm is present on the surface of the optical glass element following press molding. In this regard, the surface of the optical glass element following press molding is the surface that has been prepared by press molding with the molding surface of the press mold.

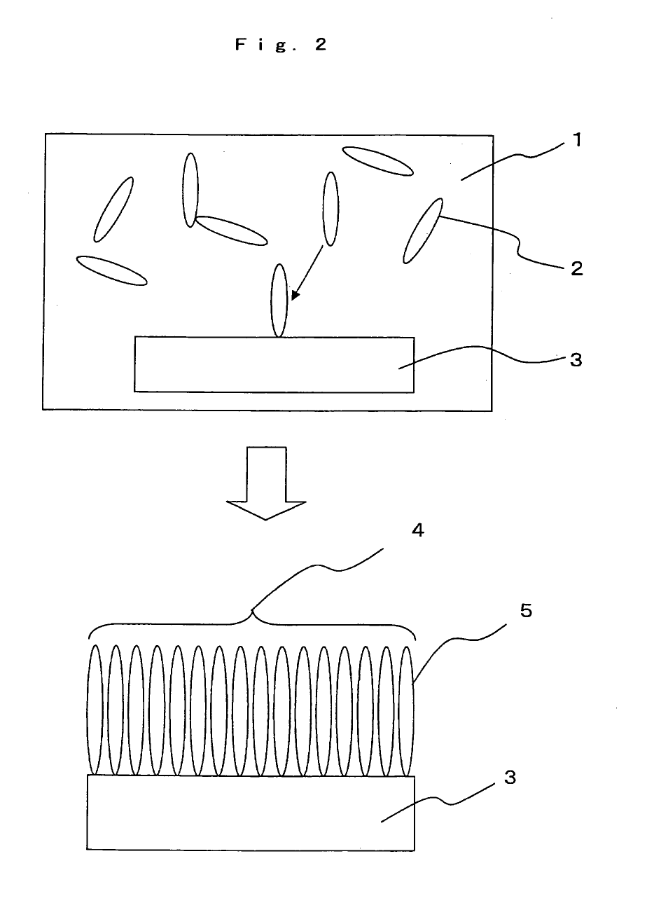

Self-assembled films are known in the literature; for example, see Hiroyuki SUGIMURA, Osamu TAKAI: Research Materials of the 199^{th} Meeting of the 131^{st} Committee on Thin Films of the Japan Society for the Promotion of Science, Feb. 1, 2000, pp. 34-39; and Seunghwan Lee, Young-Seok Shon, Ramon Colorado, Jr., Rebecca L. Guenard, T Randall Lee, and Scott S. Perry: Langmuir Vol. 16 (2000), pp. 2220-2224. As shown in FIG. 2, the functional groups of molecules 2 in solution 1 automatically react with the surface of base material to be coated with film 3, automatically and spontaneously arranging and organizing themselves on the surface of base material to be coated with film 3 into the structure of film 4.

In the present invention, a glass material with a self-assembled film has on its outermost surface an association of organic compound molecules in uniform arrangement, resulting in reduced conflict with a material in contact. For example, a specific organic compound molecule is selected; a glass material is exposed to a solution containing a specified concentration of the organic compound molecule in an organic solvent; and reaction conditions are controlled to form a single molecule organic film of uniformly oriented organic compound molecules. Since the film is formed by causing the organic compound molecules to react with the surface of the base material to be coated with film and assemble themselves, film formation is possible with an extremely high coating rate.

It is also possible to pretreat the glass surface to achieve efficient film formation. This film is stable with respect to thermodynamics, and physical and chemical properties such as surface free energy can be controlled depending on properties of terminal function groups of the organic compound molecules employed.

Examples of the organic compound molecule are reactive organic silicon-containing compounds, organic sulfur-containing compounds, organic fluorine-containing compounds, and organic nitrogen-containing compounds. Examples of the functional groups in the organic compounds that are capable of automatically and spontaneously reacting with the surface of the base material to be coated with film (glass) are primarily —Cl groups in organic silicon-containing compounds (reaction equation (1) below), primarily —H and (S—S) groups in organic sulfur-containing compounds (reaction equations (2) and (3) below), and primarily —H groups in organic nitrogen-containing compounds (reaction equation (4) below).

For example, the following may be employed in the reaction of the functional group of molecule 2 of solution 1 and the surface of base material to be coated with film 3: chlorotrialkyl silane compounds, dichlorodialkyl silane compounds, and trichloroalkyl silane compounds. When there is a group having a chlorine atom in the organic compound, it becomes the reactive functional group. As shown in reaction equation (1), it reacts automatically and spontaneously with the —OH group of the surface of base material to be coated with film 3, and a self-assembled film with the above-described compound as the starting material is formed on the surface of base material to be coated with film 3.

Reaction equation (1)

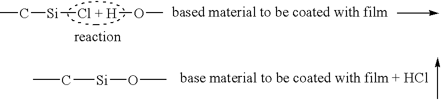

The above reaction takes place because a clean glass surface is highly reactive and reacts with water molecules in the air when the glass is exposed to the atmosphere, covering the entire surface of the glass with —OH groups.

Further, in the case of alkanethiol compounds, for example, the H atom bonding to the S atom in the thiol group of the compound becomes the functional group, and as is shown in reaction equation (2), reacts automatically and spontaneously with the —OH group on the surface of base material to be coated with film 3. A self-assembled film is formed on the surface of base material to be coated with film 3 with the above-described compound as starting material.

Reaction equation (2):

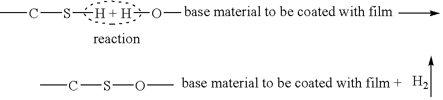

Further, in the case of dialkyldisulfide compounds, for example, the S—S bond in the compound becomes the functional group, and as is shown in reaction equation (3), reacts automatically and spontaneously with the —OH group on the surface of base material to be coated with film 3. A self-assembled film is formed on the surface of base material to be coated with film 3 with the above-described compound as starting material.

Reaction equation (3):

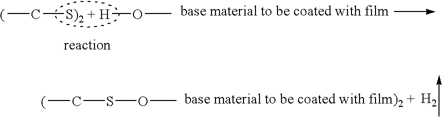

In the case of dimethylammonium compounds and alkyldimethyl (dimethylamino) silane compounds, the H atom bonded to the N atom in the compound serves as the functional group, and as shown in reaction equation (4), reacts automatically and spontaneously with the —Cl group on the surface of base material to be coated with film 3. A self-assembled film is formed on the surface of base material to be coated with film 3 with the above-described compound as starting material.

Reaction equation (4):

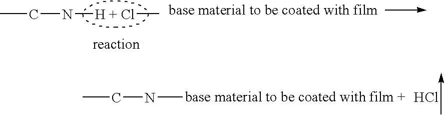

The above reaction takes place in a state in which the glass surface is exposed to a dry atmosphere containing chlorine and the surface is covered with —Cl groups.

As set forth above, it is necessary for a compound having a functional group automatically or spontaneously reacting with the —OH group or —Cl group of the surface of the base material to be coated with film to be brought into contact with the surface of the base material to be coated with film in a state in which the reactivity of the functional group is preserved to form a self-assembled film. For example, when an organic compound, a starting material of a self-assembled film, is placed in an atmosphere comprising considerable quantities of water or chlorine, the reactivity of the functional group tends to be lost. Accordingly, the organic compound is desirably stored in a state in which the reactivity of the functional group is maintained.

In the reaction to form a self-assembled film, it is desirable that the reaction rate is high. As stated for reaction equations (1) to (4), —Cl groups, —H groups, and (S—S) groups are desirable because of their high reaction rates. Alternatively, when a starting material having a functional group with a low reaction rate such as an OR group (alkoxy group) is employed, the reaction shown in reaction equation (5) below takes place. However, this reaction progresses slowly and the film formation rate is correspondingly low.

Reaction equation (5)

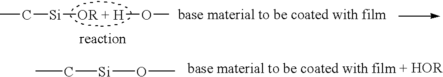

Further, although the organic compound molecule serving as the starting material for the self-assembling film employed in the present invention has the above-listed functional group on one terminal, it may have an alkyl group, aryl group, vinyl group, epoxy group, or fluorine on the other terminal (the surface terminal side when the above functional group is taken as the binding terminal). When a C—H group is present on the surface terminal side, there is good binding to the carbon-based mold-separation film, which is useful and thus desirable. An alkyl group or aryl group is preferable.

In English, self-assembled films are called “self-assembled monolayers” (SAMs). Although the term self-assembled film sometimes refers to the monolayer formed during an individual cycle in film formation processing, such monolayers can be repeatedly formed into multilayer films. When the carbon film in the present invention is a self-assembled film, the term “self-assembled film” is used to include both monolayers and multi layers.

The presence and thickness of a self-assembled film on the glass surface can be detected and measured by ESCA (XPS: X-ray photoelectron spectroscopy) or ellipsometry.

The self-assembled film relating to the present invention can be selected from the group comprising trialkylsilane compounds, dialkylsilane compounds, alkylsilane compounds, alkyldimethylsilane compounds, alkanethiol compounds, dialkylsulfide compounds, dialkyldisulfide compounds, and dimethylammonium compounds.

The self-assembled film of the present invention can be formed with the following materials. That is, at least one of compound selected from the followings can be used. Examples of chlorotrialkyl silane compounds are: chlorotrimethyl silane, chlorotriethyl silane, pentafluorophenyl dimethylchlorosilane, tert-butyldimethyl chlorosilane, (3-cyanopropyl)dimethyl chlorosilane, chlorotrifluoromethyl silane, and derivatives thereof. Examples of dichlorodialkyl silane compounds are dichlorodimethyl silane, dichloromethylvinyl silane, dichlorodifluoromethyl silane, dichloro-n-octadecylmethyl silane, n-octylmethyl dichlorosilane, dichlorocylcohexylmethyl silane, and derivatives thereof. Examples of trichloroalkyl silane compounds are trichlorovinyl silane, n-octadecyl trichlorosilane, isobutyl trichlorosilane, n-octafluorodecyl trichlorosilane, cyanohexyl trichlorosilane, and derivatives thereof. An example of a trichloroaryl silane compound is phenyl trichlorosilane. Examples of alkyldimethyl(dimethylamido) silane compounds are trimethyl(dimethylamide) silane, triethyl(dimethylamido) silane, pentafluorophenyldimethyl(dimethylamido) silane, trifluoromethyl(dimethylamido)silane, tert-butyldimethyl(dimethylamido)silane, (3-cyanopropyl)dimethyl(dimethylamido)silane, and derivatives thereof. Examples of alkanethiol compounds are 1-butanethiol, 1-decanethiol, 1-fluorodecanethiol, o-aminothiophenol, 2-methyl-2-propanethiol, n-octadecanethiol, and derivatives thereof. Examples of dialkylsulfide compounds are ethyl methyl sulfide, dipropyl sulfide, n-hexyl sulfide, fluoroethylmethyl sulfide, phenylvinyl sulfide, and derivatives thereof. Ethyl phenyl sulfides and derivatives thereof. Examples of dialkyldisulfide compounds are p-tolyldisulfide, diallyldisulfide, methylpropyldisulfide, fluoromethylpropyldisulfide, difurfuryldisulfide, derivatives thereof. Methylphenyldisulfide and derivatives thereof. Examples of dimethylammonium compounds are dihexadecyldimethylammonium acetate, dioctadecyldimethylammonium acetate, dieicosyldimethylammonium bromide, dimethyldioctadecylammonium iodide, dioctafluorodecyldimethylammonium acetate, dimethyldioleylammonium iodide, and derivatives thereof.

The starting material of the self-assembled film is not limited to the above-mentioned compounds and any compounds which generate a carbon film by heating at pressing can be employed as well.

The self-assembled film of the present invention is desirably a surface layer formed by immersing preformed glass in an organic solution (referred to hereinafter as a “coating solution”) in which the above-described organic compound molecules serving as the starting materials for the self-assembled film have been dissolved. The solvent employed in the organic solution is desirably an anhydrous organic solvent. This is to avoid causing the organic compound molecules in the starting materials to lose their reactivity due to reaction with water molecules. When a solvent having polarity is employed, bonds are also similarly formed with the organic compound molecules, causing the organic compound molecules to lose their reactivity. Thus, a nonpolar solvent is desirably selected. That is, the solvent employed is desirably selected from among solvents maintaining the reactivity of the functional groups of the organic compound molecules. Specific examples of preferred solvents are anhydrous nonpolar organic solvents such as hexane, anhydrous organic solvents such as toluene, chloroform, and mixtures of these solvents. Immersing is advantageous because it is a simple treatment not necessitating a large-scale facility.

When diluting the starting compounds of the self-assembled film with organic solvents having polarity such as alcohols, the functional group sometimes reacts with the —OH group in the alcohol, as shown in reaction equation (6) below, causing the functional group to be lost and causing the compounds to tend not to react with the —OH group or a —Cl group of the surface of the base material to be coated with film. Thus, the organic solvent desirably does not contain an —OH group.

Reaction equation (6)

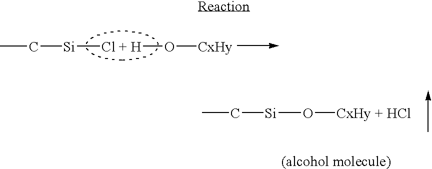

The concentration of the starting materials in the above coating solution desirably falls within the range of from 0.01 to 10 weight percent, preferably within the range of 0.1 to 5 weight percent. An excessively low concentration results in an inadequate coating rate, and an excessively high concentration does not raise the coating rate, conversely tending to decrease it.

In addition to the immersion method, preformed glass can be exposed to a vapor, mist, gas, or the like containing the starting material of the self-assembling film to obtain a self-assembled film.

As shown in FIG. 1, in a self-assembled film, the molecules 2 in the film are orderly arranged on the surface of a base material 3 as the result of an automatic and spontaneous reaction between the functional groups of a starting material and the base material being coated 3. Accordingly, when forming a self-assembled film, the arrangement of atoms with a regularity can be detected by surface analysis such as IR-RAS exhibiting a peak reflecting IR activity for the bonding state.

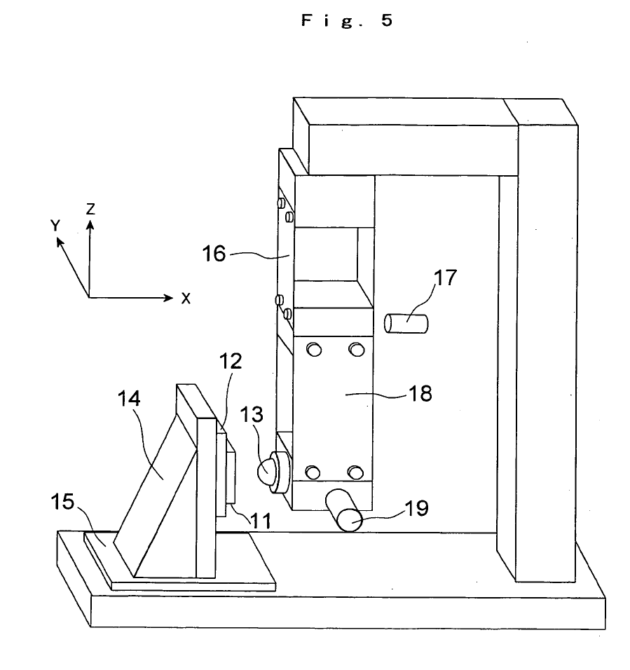

In other words, a peak derived from the regular arrangement of atoms is observed in IR-RAS analysis when a self-assembled film has been formed (as shown in FIG. 4). However, no peak is observed for a film that is not a self-assembled film and thus does not having orderly arranged molecules. Further, electron spectroscopy for chemical analysis (ESCA) (X-ray photoelectron spectroscopy) and time of flight secondary ion mass spectrometry (TOF-SIMS) permit the identification of the atoms at the interface between the coated base material and the film, indicating that the above regular arrangement is derived from a self-assembled film.

The thickness of the self-assembled film can be controlled through the length of the carbon chain of the starting material employed, as described in the literature (Pehong Cong, Takashi Igari, and Shigeyuki Mori, “Effects of film characteristics on frictional properties of carboxylic acid monolayer”, Tribology Letters 9 (2000) pp. 175-179). The thickness TS (nm) of a self-assembled film can be approximately estimated from the equation below from the number N of carbon atoms in the carbon chain.

TS (nm)≈0.2×N

The chemical bond length assumes a certain value based on the type of atoms at the two ends of the bond and the type of bond. The primary chain forming a self-assembled film is —CH₂—CH₂—. The chemical bond length between the carbon atoms each jointly bonded to two hydrogen atoms is about 0.2 nm per carbon atom based on the van der Waals radius (0.17 nm) of a carbon atom and bond angle between carbon atoms.

The self-assembled film provided on the glass material surface is converted to a film comprised primarily of carbon by heat during pressing. However, in addition to the primary element of carbon in the film, atoms derived from the starting material, such as hydrogen, silicon, fluorine, and sulfur, can be contained up to a limit of 30 at %.

The reason the maximum thickness of the self-assembled film in the third and fourth modes of the method of manufacturing optical glass elements of the present invention is limited to less than or equal to 10 nm is the same as the reason the maximum thickness of the carbon film of the first and second modes of the method of manufacturing optical glass elements of the present invention is limited to less than or equal to 10 nm.

Further, the self-assembled film in the third and fourth modes of the method of manufacturing optical glass elements of the present invention is formed so that, on the surface of the glass optical element following press molding, a carbon film of a thickness comprising at least two carbon atom layers is present and a carbon film at least 0.5 nm in thickness is present. The reasons of these are respectively the same as the reasons for which the carbon films in the first and second modes of the method of manufacturing optical glass elements of the present invention set forth above are formed so that a carbon film having a thickness comprising at least two carbon atom layers and a carbon film having a thickness of at least 0.5 nm are present. This is because the self-assembled film provided on the glass element surface is converted to a film comprising primarily carbon by heating during pressing. The self-assembled film present on the surface of the glass material is desirably formed so that a carbon film at least 0.8 nm in thickness is present.

Although the present inventors discovered that it was possible to effectively prevent fusion during press molding by the manufacturing method of the present invention as set forth above, they conducted further detailed study into preventing fogging of molded optical elements. As a result, they further discovered the following.

That is, the main reason for fogging of the surface of optical elements is alteration due to reaction of the surface of the pressing mold, compromising surface properties. As the result of various investigation of this deterioration in the surface of the pressing mold, it was found to be the result of a corrosive reaction due to highly reactive hydrogen released from the surface layer of the glass material. This hydrogen released by the glass material was found to be caused by active hydrogen generated during the formation of the carbon film on the glass material being absorbed by the surface layer of the glass material. Accordingly, based on this information, the carbon film provided on the surface of the glass material is desirably formed under conditions preventing the generation of active hydrogen during film formation to prevent the generation of active hydrogen from the glass material upon which the carbon film has been provided.

Accordingly, in the manufacturing method of the present invention, the carbon film or self-assembled film is desirably formed so that the rate of increase in the hydrogen content of the surface layer portion from the glass surface of the glass material to a depth of 500 nm is less than or equal to 5 at %.

That is, the carbon film or self-assembled film is desirably formed on the glass material in such a manner that the hydrogen content of the portion from the glass surface of the glass material upon which the carbon film or self-assembled film is formed to a depth of 500 nm (glass outer layer portion) desirably does not increase by more than 5 at % over the hydrogen content of the portion from the surface of the glass material to a depth of 500 nm prior to formation of the carbon film or self-assembled film.

Although hydrogen atoms deriving from the original glass composition are present in the glass material, an increase in the hydrogen content of the outer layer (outer layer to a depth of 500 nm) of the glass material due to the formation of a carbon film means that active hydrogen has been incorporated into the glass by formation of the carbon film. Accordingly, the carbon film is desirably formed under conditions that inhibit an increase in the hydrogen content.

For example, when the carbon film is formed under conditions of plasma treatment with a hydrocarbon at elevated temperature, highly reactive hydrogen atoms (or hydrogen radicals) are released, which tend to be incorporated into the surface layer of the glass material. When these hydrogen atoms (or radicals) are reheated to high temperature during press molding, they react with the carbon film on the molding surface at the boundary between the glass and the molding surface, damaging the carbon film in the following manner.

hydrogen radical+carbon CH×↑

The present inventors investigated the dependence of fogging on the hydrogen content of the surface layer of the glass material in the course of the formation of the carbon film on the surface of the glass material. As a result, they found that in glass materials having carbon films, keeping the hydrogen content of the portion from the surface of the glass material to a depth of 500 nm from increasing by more than 5 at % over the hydrogen content of the portion from the surface of the glass material to a depth of 500 nm prior to formation of the carbon film was desirable because it resulted in extremely little fogging. That is, the carbon film is desirably formed using methods and under conditions that keep the increase in hydrogen content set forth above to less than or equal to 5 at %. This also includes the case where the increase in hydrogen content is 0 percent.

The hydrogen content of the surface layer of the glass material employed in molding is analyzed by ESCA (XPS: X-ray photoelectron spectroscopy) or SIMS (secondary ion mass spectrometry).

The hydrogen in the carbon film or self-assembled film formed on the surface of a glass material employed in molding is of low reactivity. Accordingly, there is little clouding or fogging so long as the hydrogen content of the carbon film is less than 50 at %, with less than 30 at % being preferred.

As previously stated, desirable methods of forming the carbon film on the glass material in the present invention include vapor deposition, sputtering, ion plating, and self-assembled film formation. A carbon film or self-assembled film formed by one of these methods tends not to produce the above-described active hydrogen; accordingly, the fogging accompanying press molding can be effectively prevented. In film forming methods such as plasma treatment and heat decomposition CVD of a hydrocarbon gas such as methane or acetylene, for example, a high concentration of active hydrogen tends to enter the surface layer of the glass material employed in molding even when high-purity gas starting materials are employed. As a result, deterioration of the surface of the pressing mold sometimes occurs.

In particular, to keep the increase in the hydrogen content to less than or equal to 5 at % in vapor deposition, it is desirable to (I) keep the content of hydrogen impurities in the carbon vapor deposition source and those adsorbed onto the surface to less than or equal to 1 at %, or (2) keep the hydrogen concentration in a vacuum atmosphere to less than or equal to 1 ppm.

To keep the content of hydrogen impurities in the carbon vapor deposition source and those adsorbed onto the surface to less than or equal to 1 at %, it is desirable to employ a carbon vapor deposition source of high-purity carbon of greater than or equal to 99.9 percent (3N) and, prior to vapor deposition, conduct preheating to greater than or equal to 300° C. under 10⁻² Torr or less to remove adsorbed substances such as adsorbed water functioning as sources of hydrogen impurities.

In ion plating, to keep the above increase in hydrogen content to less than or equal to 5 at %, it is desirable to (1) keep the content of hydrogen impurities in the carbon source and adsorbed onto the surface to less than or equal to 1 at % or (2) keep the hydrogen concentration in an argon atmosphere to less than or equal to 1 ppm. As above, adsorbed matter and the purity of the carbon source are desirably taken into account.

In sputtering, to keep the above increase in hydrogen content to less than or equal to 5 at/%, it is desirable to (1) keep the content of hydrogen impurities in the carbon target and on the adsorption surface to less than or equal to 1 at % or (2) keep the hydrogen concentration in the argon atmosphere to less than or equal to 1 ppm. As above, adsorbed matter and the purity of the carbon source are desirably taken into account.

In self-assembled film formation, to keep the above increase in hydrogen content to less than or equal to 5 at %, it is desirable to conduct heating of the base material prior to formation of the self-assembled film, such as during drying following cleaning, in an atmosphere with a hydrogen concentration of less than or equal to 0.1 vol %.

That is, in the course of forming a carbon film or self-assembled film on the surface of the glass material in the present invention, the content of carbon in the portion of the surface layer from the surface of the glass material to a depth of 500 nm is desirably kept from increasing by more than 5 at % due to film formation.

The method of manufacturing glass elements of the present invention will be described below in greater detail.

(Step of Preparing a Glass Material Having a Carbon Film or Self-Assembled Film)

A carbon film or self-assembled film is formed by a method selected from among vapor deposition, ion plating, sputtering, and self-assembled monolayer (SAM) formation on the surface of a glass material that has been preformed in advance to a specified shape such as spherical, oblate spherical, or tabular, and cleaned. However, prior to film formation, the rate of expansion S(L)/S(PF) of the portion undergoing the greatest extension and expansion in surface area due to press molding is calculated in the manner given below, the minimum value of the carbon film or self-assembled film is set, and the actual thickness of the carbon film or self-assembled film to be formed on the glass material is determined from among the thickness range of carbon films or self-assembled films satisfying thickness T in the equation below.

Letting S(PF) denote the surface area of the glass material at a specific spot and S(L) denote the surface area of the portion corresponding to that spot on the lens formed by press molding, the expansion rate at that particular spot is given by S(L)/S(PF). The expansion rate is calculated by the method set forth above.

0.5×S(L)/S(PF)≦T<10 nm

(Preferably: 0.6×S(L)/S(PF)≦T≦10 nm)

Prior to carbon film formation, the glass material employed in molding desirably has a free surface energy of greater than or equal to 60 mJ/m². This is because when the surface of the glass material is contaminated, the free surface energy prior to formation of the carbon film decreases, foreign matter that is adsorbed at such times reacts with the molding surface, and fogging results. The free surface energy is a value, for example, that can be analyzed using a commercial contact angle measuring device and measuring the wetting angle of the surface of the glass material employed in molding by pure water and CH₂I₂. For example, the free surface energy can be calculated by the Owens-Wendt-Kaelble method from the value obtained by the above wetting angle measurement.

(The Press Molding Step)

A glass material on the surface of which has been formed a carbon film or self-assembled film is press molded by the usual method to obtain an optical glass element. For example, a glass material is introduced into a pressing mold that has been processed to a precise shape. The glass material is then softened by heating to a temperature corresponding to a glass material viscosity of 10⁸ to 10¹² poises and pressed by the mold to transfer the molding surface of the mold to the glass material. It is also possible to introduce into a pressing mold that has been processed to a precise shape a glass material that has been preheated to a temperature corresponding to a glass material viscosity of 10⁸ to 10¹² poises and press the glass material to transfer to the glass material the molding surface of the mold. To prevent oxidation of the molding surface, the atmosphere during molding is desirably non-oxidizing. Subsequently, the mold and the glass material are cooled, and once they have reached a temperature below Tg, the molded optical element is separated from the mold and recovered.

The step of forming a carbon film or self-assembled film and the step of press molding can be continuously conducted. That is, a glass material on the surface of which has been formed a carbon film or self-assembled film can be heated and press molded as is.

A material selected from among SiC, WC, TiC, TaC, BN, TiN, AlN, Si₃N₄, SiO₂, Al₂O₃, ZrO₂, W, Ta, Mo, cermet, cyalon, mullite, carbon composite (C/C), carbon fiber (CF), WC—Co alloy, glass materials comprising crystallized glass, and stainless steel-based highly heat resistant metals can be employed as the base metal of the mold.

A mold-separation film is desirably provided on the surface of the base material of the mold. Diamond-like carbon film (DLC hereinafter), hydrogenated diamond like carbon film (DLC:H hereinafter), tetrahedral amorphous carbon film (ta-C hereinafter), hydrogenated tetrahedral amorphous carbon film (ta-C:H hereinafter), amorphous carbon film (a-C hereinafter), hydrogenated amorphous carbon film (a-C:H hereinafter), carbon-based films such as nitrogen-comprising carbon films, and alloy films comprising at least one metal selected from among the group consisting of platinum (Pt), palladium (Pd), iridium (Ir), rhodium (Rh), osmium (Os), ruthenium (Ru), rhenium (Re), tungsten (W), and tantalum (Ta) may be employed as the mold-separation film.

Further, the mold-separation film may be formed by a method such as the DC-plasma CVD method, RF-plasma CVD method, microwave plasma CVD method, ECR-plasma CVD method, optical CVD method, laser CVD method, or some other plasma CVD method; the ion plating method or some other ionization vapor deposition method; sputtering; vapor deposition; the filtered cathodic arc (FCA) method; or the like.

In addition to being effective for the manufacturing of optical elements such as lenses, mirrors, gratings, prisms, microlenses, stacked diffraction optical elements, and the like, the manufacturing method of the present invention is suited to molded glass articles other than optical elements. It is particularly effective in the manufacturing of glass lenses having mounting portions of low thickness (for example, less than or equal to 1 mm) around the edge of an optically nonfunctional surface, concave lenses with a center thickness of less than or equal to 1 mm, and the like.

The type of glass suited to the present invention is not specifically limited. The present invention is particularly effective for readily cracking borate based glasses, phosphate based glasses, borophosphate based glasses, fluorophosphate based glasses, and the like.

[Embodiments]

The present invention is described with greater specificity below through embodiments.

Embodiment 1

A glass material for molding that had been preformed as a sphere 4.5 mm φ in diameter was procured (alkali-containing borate glass, free surface energy after cleaning of 65 mJ/m²). This was press molded to obtain a biconvex lens of the shape shown in FIG. 3 with a diameter of 7.5 mm φ, a primary surface radius of curvature of 7 mm, a secondary surface radius of curvature of 5 mm, and an edge thickness of 0.7 mm. Preliminary molding was used to determine that the spot undergoing the greatest expansion in surface area during press molding was the flat portion along the rim. At that spot, it was determined that S(L)/S(PF)=5.2. It was then determined that a carbon film formed on the original glass material that was 0.5×5.2≦T≦10 (nm) in thickness would suffice.

Accordingly, a carbon film 4.5 nm in thickness was formed by vapor deposition on the glass material. The thickness of the carbon film was measured by ESCA. To keep the content of hydrogen impurities in the carbon vapor deposition source and those adsorbing onto the surface to less than or equal to 1 at %, a carbon vapor deposition source of 99.99 percent (4N) high-purity carbon was employed and, prior to vapor deposition, heating was conducted for 30 min. at 300° C. under a high vacuum of 10⁻⁴ Torr. Vapor deposition was conducted in a vacuum atmosphere of 10⁻⁴ Torr by passing 100 V-40 A of electricity through a carbon material of about 0.1 cm² in cross-sectional area to heat the carbon material. The base material was heated to a temperature of 150° C. and carbon was vapor deposited to achieve the above-stated film thickness. ESCA analysis of the hydrogen content of the surface layer of the glass material (the area from the surface to a depth of 500 nm) revealed no increase in the hydrogen content due to the formation of the carbon film by vapor deposition.

The glass material employed in the present embodiment had a glass transition temperature of 520° C., a refractive index of 1.69350, and a linear expansion coefficient of 69×10⁻⁷/° C.

Next, the glass material coated with a carbon film thus obtained was placed in a pressing device having a molding surface that had been precision processed based on the above-stated lens shape. Heating was conducted in a nitrogen gas atmosphere to 610° C. and pressing was conducted for 1 min. at a pressure of 150 kg/cm².

After releasing the pressure, cooling was conducted at a rate of −50° C./min to 480° C., followed by cooling at a rate of −200° C./min or more. When the temperature of the press-molded product had decreased to below 200° C., the molded optical element was removed.

Measurement by ESCA revealed the thickness of the carbon film on the surface of the optical element to be 0.9 nm at the spot of greatest extension. The thickness of the carbon film at other spots was 1.5 nm or greater.

The pressing mold employed was obtained by using CVD to form a polycrystalline SiC molding surface, polishing it to a mirror surface of Rmax=18 nm, and employing an ion-plating film formation device to form a DLC:H film on the molding surface.

In the press molding conducted under the conditions set forth above, 5,000 shots were continuously pressed and no flaws or cracking appeared. The external appearance of all of the optical elements was good, with no visible fogging observed.

### COMPARATIVE EXAMPLE 1

Employing the same glass materials as in Embodiment 1, a carbon film was vapor deposited to obtain glass materials having a carbon film 20 nm in thickness (as measured by ESCA). When the hydrogen content of the surface layer (the area from the surface layer to a depth of 500 nm) of the glass materials for molding was measured by ESCA, no increase in hydrogen quantity due to formation of the carbon film was found.

As in Embodiment 1, a single mold was employed in continuous pressing. When the thickness of the carbon film on the molded optical elements was measured by ESCA, there were portions in which the carbon film had parted so that no carbon film was present; in portions where the carbon film was present, the film thickness was about 15 nm. When pressing was continued, cracks appeared in the optical elements and fused material thought to be glass was found on the pressing mold at 600 shots. No further pressing was possible with that particular pressing mold; regeneration of the mold-separation film on the surface of the pressing mold was necessary.

### COMPARATIVE EXAMPLE 2

Employing the same glass materials as in Embodiment 1, a carbon film was vapor deposited to obtain glass materials having a carbon film 0.7 nm in thickness (as measured by ESCA). When the hydrogen content of the surface layer (the area from the surface layer to a depth of 500 nm) of the glass materials for molding was measured by ESCA, no increase in hydrogen quantity due to formation of the carbon film was found. When continuous pressing with a single mold was begun in the same manner as in Embodiment 1, cracking appeared during the initial period of pressing. The thickness of the carbon film on the molded optical elements was subjected to surface friction analysis with the friction gauge shown in FIG. 5, yielding the output shown in FIG. 7c). That is, the requirement of a thickness of two carbon atoms was clearly not met.

Embodiment 2

Employing the same glass materials as in Embodiment 1, the carbon film was formed by thermal decomposition of high-purity acetylene gas to obtain glass materials having a carbon film 4.5 nm in thickness (as measured by ESCA). A CVD device was employed in film formation. The interior of a bell jar was evacuated to 0.5 Torr or below with a vacuum pump, after which a temperature of 480° C. was maintained by heating. While introducing nitrogen gas into the bell jar, evacuation was conducted with the vacuum pump to maintain 160 Torr, and following a 30 min purge, the introduction of nitrogen gas was halted. After evacuating the interior of the bell jar to below 0.5 Torr with the vacuum pump, acetylene gas was introduced over 210 min to 210 Torr and a carbon film was formed on the surface of the glass material.

ESCA analysis of the hydrogen content of the surface layer (the area from the surface to a depth of 500 nm) of the glass materials employed in molding revealed that the increase in the amount of hydrogen due to carbon film formation was 20 at %. When continuous pressing was conducted with a single mold in the same manner as in Embodiment 1, cracking appeared when the number of shots exceeded 2,000.

Embodiments 3 to 11

With the exception that the glass materials employed in molding, the method of forming the carbon film, and the thickness of the carbon film were varied as shown in Tables 1 to 3, glass materials for molding upon which carbon films had been formed were continuously pressed with a single mold as in Embodiment 1 up to 5,000 shots. Embodiments 7 and 8 are examples in which self-assembled films were formed instead of carbon films.

As indicated in Tables 1 to 3, observation of the external appearance of the optical elements obtained by press molding revealed no fogging, clouding, or cracking in any of the optical elements; extremely good external appearance was exhibited in all cases.

TABLE 1
List of Embodiments and Comparative Examples

| Conditions | Embodiment 1 | Comp. Ex. 1 | Comp. Ex. 2 | Embodiment 2 | Embodiment 3 |
|---|---|---|---|---|---|
| Glass material | Borate glass | Borate glass | Borate glass | Borate glass | Borate glass |
| (Tg/Ts) | (520° C./560° C.) | (520° C./560° C.) | (520° C./560° C.) | 520° C./560° C.) | (520° C./560° C.) |
| Shape of glass | Spherical | Spherical | Spherical | Spherical | Spherical |
| material | | | | | |
| Free surface | 65 | 62 | 63 | 65 | 62 |
| energy after | | | | | |
| cleaning | | | | | |
| (mJ/m²) | | | | | |
| Spot of greatest | Peripheral | Peripheral | Peripheral | Peripheral | Peripheral |
| expansion in | portion of lens | portion of lens | portion of lens | portion of lens | portion of lens |
| surface area | | | | | |
| S(L)/S(PF) at | 5.2 | 5.2 | 5.2 | 5.2 | 3.4 |
| spot of greatest | | | | | |
| expansion in | | | | | |
| surface area | | | | | |
| Method of | Vapor | Vapor | Vapor | Thermal | Sputtering |
| forming carbon | deposition | deposition | deposition | decomposition | |
| film | | | | of acetylene | |
| | | | | gas | |
| Thickness of | 4.5 | 20 | 0.7 | 4.5 | 3.2 |
| carbon film on | | | | | |
| surface of glass | | | | | |
| material (nm) | | | | | |
| Thickness of | 0.9 | (separated) | less than 0.5 | 0.9 | 0.9 |
| carbon film on | | | | | |
| lens at spot of | | | | | |
| greatest | | | | | |
| expansion in | | | | | |
| surface area | | | | | |
| Increase in | 0 | 0 | 0 | 20 | 0 |
| hydrogen | | | | | |
| content of | | | | | |
| surface layer of | | | | | |
| molding glass | | | | | |
| material due to | | | | | |
| formation of | | | | | |
| carbon film | | | | | |
| (at %) | | | | | |
| Mold material | SiC | SiC | SiC | SiC | SiC |
| Mold- | DLC: H | DLC: H | DLC: H | DLC: H | ta-C |
| separation film | | | | | |
| on molding | | | | | |
| surface | | | | | |
| External | ⊚ | X | X | Δ | ⊚ |
| appearance of | | | | | |
| optical | | | | | |
| element* | | | | | |

TABLE 2
List of Embodiments and Comparative Examples (cont'd)

| Conditions | Embodiment 4 | Embodiment 5 | Embodiment 6 | Embodiment 7 |
|---|---|---|---|---|
| Glass material | Borosilicate glass | Borosilicate glass | Phosphate glass | Borosilicate glass |
| (Tg/Ts) | (500° C./535° C.) | (500° C./535° C.) | (365° C./403° C.) | (515° C./545° C.) |
| Shape of glass | Gob (oblate | Gob (same as | Spherical | Gob (oblate |
| material | spherical) | left) | | spherical) |
| Free surface | 61 | 66 | 60 | 71 |
| energy after | | | | |
| cleaning | | | | |
| (mJ/m²) | | | | |
| Spot of greatest | Peripheral portion | Center portion | Peripheral portion | Center portion |
| expansion in | of lens | | of lens | |
| surface area | | | | |
| S(L)/S(PF) at | 1.8 | 2.2 | 3.1 | 2.8 |
| spot of greatest | | | | |
| expansion in | | | | |
| surface area | | | | |
| Method of | Vapor deposition | Sputtering | Vapor deposition | Sputtering |
| forming carbon | | | | |
| film | | | | |
| Thickness of | 6.3 | 2.5 | 4.0 | 4.0 |
| carbon film on | | | | |
| surface of glass | | | | |
| material (nm) | | | | |
| Thickness of | 3.5 | 1.1 | 1.3 | 1.4 |
| carbon film on | | | | |
| lens at spot of | | | | |
| greatest | | | | |
| expansion in | | | | |
| surface area | | | | |
| Increase in | 0 | 0 | 5 | 0 |
| hydrogen | | | | |
| content of | | | | |
| surface layer of | | | | |
| molding glass | | | | |
| material due to | | | | |
| formation of | | | | |
| carbon film | | | | |
| (at %) | | | | |
| Mold material | WC | WC | Stainless steel | SiC |
| Mold- | Pt | DLC | Pt | None |
| separation film | | | | |
| on molding | | | | |
| surface | | | | |
| External | ⊚ | ⊚ | ◯ | ⊚ |
| appearance of | | | | |
| optical | | | | |
| element* | | | | |

TABLE 3
List of Embodiments and Comparative Examples (cont'd)

| Conditions | Embodiment 8 | Embodiment 9 | Embodiment 10 | Embodiment 11 |
|---|---|---|---|---|
| Glass material | Borosilicate glass | Borate glass | Borate glass | Borate glass |
| (Tg/Ts) | (500° C./540° C.) | (560° C./600° C.) | (555° C./595° C.) | (550° C./590° C.) |
| Shape of glass | Gob (oblate | Gob (same as left) | Gob (same as left) | Spherical |
| material | spherical) | | | |
| Free surface | 73 | 68 | 71 | 62 |
| energy after | | | | |
| cleaning | | | | |
| (mJ/m²) | | | | |
| Spot of greatest | Peripheral portion | Center portion | Peripheral portion | Peripheral portion |
| expansion in | of lens | | of lens | of lens |
| surface area | | | | |
| S(L)/S(PF) at | 1.7 | 1.9 | 2.4 | 3.4 |
| spot of greatest | | | | |
| expansion in | | | | |
| surface area | | | | |
| Method of | SAM film | SAM film | Vapor deposition | Vapor deposition |
| forming carbon | formation; | formation; | | |
| film | immersion for 60 sec | immersion for 120 sec | | |
| | in 20° C. hexane | sec in 20° C. hexane | | |
| | solution of 1 wt % | solution of 2 wt % | | |
| | chlorotrimethyl | chlorotrimethyl | | |
| | silane | silane | | |
| Thickness of | 2.8 | 2.8 | 7.5 | 7.5 |
| carbon film on | | | | |
| surface of glass | | | | |
| material (nm) | | | | |
| Thickness of | 1.6 | 1.5 | 3.1 | 2.2 |
| carbon film on | | | | |
| lens at spot of | | | | |
| greatest | | | | |
| expansion in | | | | |
| surface area | | | | |
| Increase in | 0 | 0 | 2 | 0 |
| hydrogen | | | | |
| content of | | | | |
| surface layer of | | | | |
| molding glass | | | | |
| material due to | | | | |
| formation of | | | | |
| carbon film | | | | |
| Mold | SiC | SiC | SiC | SiC |
| Mold- | DLC | DLC | DLC: H | DLC |
| separation film | | | | |
| External | ⊚ | ⊚ | ⊚ | ⊚ |
| appearance of | | | | |
| optical | | | | |
| element* | | | | |

*External appearance of optical element: The external appearance of the optical element at 1,000 continuous pressings in a single mold.
⊚: No cracking, fogging, or clouding appearing at 5,000 pressings.
◯: At 5,000 pressings, no cracking or clouding visible. Some fogging visible, but not affecting optical performance.
Δ: At 2,000 pressings, no cracking or clouding visible. Some fogging visible, but not affecting optical performance.
X: Cracking occurring at fewer than 2,000 pressings.
(Here, the term “fogging” applies to the entire surface of the optically functional surface, while “clouding” is partial.)

1-12 (Canceled)

13. A method for manufacturing optical glass element, comprising:
forming a carbon containing film on a surface of a preformed glass material and press molding the glass material having a carbon containing film thereon by the molding surface of the pressing mold, as the glass material is heat softened state,
wherein the carbon containing film is formed on the glass material so that that the thickness thereof is less than or equal to 10 nm and so that the carbon containing film on the optical glass element which is press molded comprises at least two carbon atom layers in thickness.

14. A method for manufacturing optical glass element, comprising:
forming a carbon containing film on a surface of a preformed glass material and press molding the glass material having a carbon containing film thereon by the molding surface of the pressing mold, as the glass material is heat softened state,
wherein the carbon containing film is formed on the glass material so that that the thickness thereof is less than or equal to 10 nm and so that the carbon containing film on the optical glass element which is press molded comprises at least 0.5 nm in thickness.

15. The method of claim 13 wherein the carbon containing film is a self-assembled film.

16. The method of claim 14 wherein the carbon containing film is a self-assembled film.

17. The method of claim 13 wherein the carbon containing film formed by vapor deposition, sputtering, or ion plating method.

18. The method of claim 14 wherein the carbon containing film formed by vapor deposition, sputtering, or ion plating method.

19. The method of claim 13 wherein the thickness of the carbon containing film on the glass material is predetermined based on the shape of the glass material and the shape of the optical element.

20. The method of claim 13 wherein the carbon containing film is formed on the glass material so that a rate of increase in the hydrogen content of the glass material surface portion up to a depth of 500 nm is less than or equal to 5 at %.

21. The method of claim 13 wherein the optical element comprises an optically functional surface and an optically nonfunctional surface, said optically nonfunctional surface comprising a circumference portion which is discontinuous with the shape of the optically functional surface, formed by the press molding.

22. The method of claim 13 further comprising:
determining a highest rate of expansion in surface area due to the press molding, prior to forming the carbon containing film on the glass material,
determining a thickness of the carbon containing film to be formed on the glass material based on the rate of expansion,
forming the carbon containing film on the glass material of the determined thickness, and
press molding the glass material having the carbon containing film thereon by the molding surface of the pressing mold, as the glass material is heat softened state,
wherein the highest rate of expansion is determined by press molding a dummy glass material to obtain the dummy optical element.

23. The method of claim 22 wherein the highest rate of expansion is determined by a marks of prescribed pattern marked on the surface of the dummy glass material and marks on the surface of the dummy optical element obtained by press molding the dummy glass material.

24. A method for manufacturing optical glass element, comprising:
forming a carbon containing film on a surface of a preformed glass material and
press molding the glass material having a carbon containing film thereon by the molding surface of the pressing mold, as the glass material is heat softened state,
wherein the carbon containing film is formed on the glass material by vapor deposition or sputtering so that that the thickness thereof is less than 5 nm.

25. The method of claim 24 wherein the carbon containing film is formed so that the carbon containing film on the surface of optical glass element which is press molded comprises at least two carbon atom layers in thickness.
